(19) United States
(12) Patent Application Publication
(10) Pub. No.: US 2026/0045838 A1
(43) Pub. Date: Feb. 12, 2026

(54) ELECTRIC MACHINE WITH STATOR COOLING SYSTEM AND OPERATING METHOD

(71) Applicant: Dana Automotive Systems Group, LLC, Maumee, OH (US)

(72) Inventors: Steven VANHEE, Hooglede (BE); Jaywant S. PAWAR, Pune (IN)

(21) Appl. No.: 18/801,173

(22) Filed: Aug. 12, 2024

(51) Int. Cl. H02K 1/20; H02K 9/19; H02K 21/14

(52) U.S. Cl. CPC H02K 1/20; H02K 9/19; H02K 21/14

(57) ABSTRACT

Systems and methods for cooling an electric machine. The stator cooling system includes, in one example, multiple coolant channels arranged in a stator lamination stack or between an outer diameter of a coolant jacket and an inner diameter of a housing and multiple turbulators arranged the multiple coolant channels. The stator cooling system further includes a coolant inlet configured to deliver a coolant to multiple coolant channels and a coolant outlet configured to receive the coolant from the multiple coolant channels.

### TECHNICAL FIELD

The present disclosure relates to an electric machine with a stator cooling system that include turbulators.

### BACKGROUND AND SUMMARY

Electric motors are used in vehicles to generate motive power and in a variety of other fields. Some electric motors exhibit multiples losses such as ohmic losses, magnetic losses, iron losses, mechanical losses, and stray losses. The inventors have recognized that major ohmic loss and magnetic loss can be controlled by keeping motor operation within a desired temperature range. Some electric motors have used water-cooling assemblies that make use of a coolant jacket with helical coolant channels. Due to the high viscosity, the fluid flow through these channels is laminar with a comparatively low Reynolds number which constraints the cooling potential of the system. The low cooling potential reduces the thermal performance of the entire motor. Other motor cooling systems have made attempts to cool the stator by routing oil therethrough. For instance, U.S. Pat. No. 10,790,728 B2 discloses an electric motor with a liquid cooling system that directs oil through apertures in interior laminations in the stator, in an attempt to remove heat from the stator. However, the inventors have recognized drawbacks with the liquid cooling system disclosed in U.S. Pat. No. 10,790,728 B2 as well as other stator lamination cooling systems. For instance, the oil flow through the laminations is laminar, which again constrains the system's cooling potential and the motor's performance, more generally.

Recognizing the abovementioned drawbacks of previous motors, the inventors developed a stator cooling system for an electric machine to overcome at least a portion of the drawbacks. The stator cooling system, in one example, includes multiple coolant channels arranged in a stator lamination stack or between an outer diameter of a coolant jacket and an inner diameter of a housing. The stator cooling system further includes multiple turbulators arranged the multiple coolant channels. The stator cooling system even further includes coolant inlet configured to deliver a coolant to multiple coolant channels and a coolant outlet configured to receive the coolant from the multiple coolant channels. In this way, electric machine cooling is increased, thereby increasing electric machine performance.

In one example, the multiple coolant channels may axially extend through the stator lamination stack. In this way, a greater amount of heat is able to be removed from the stator laminations when compared to other machine cooling arrangements that direct fluid through the stator laminations or a water jacket without turbulators.

In another example, the multiple coolant channels may axially extend through a coolant jacket and the coolant jacket may be directly coupled to the stator lamination stack. In this way, the cooling channels are space efficiently incorporated into electric machine by using the housing for a portion of the boundary of the coolant channels.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

FIG. 1 shows a schematic depiction of an electric machine with a stator cooling system.

FIGS. 2-6 show a first example of a stator cooling system.

FIGS. 7-8 show a second example of a stator cooling system.

FIG. 9 shows an example of turbulators in a coolant channel.

FIG. 10 shows a graph that depicts exemplary sizes of orifices for the coolant channels.

FIG. 11 shows a detailed view of exemplary turbulators.

### DETAILED DESCRIPTION

Electric machines with stator cooling systems that achieve increased efficiency are described herein. In a first example of the stator cooling system, turbulators are used as heat transfer enhancement surfaces where multiple parallel slots are made in coolant jacket and inner diameter of a housing that is profiled to accommodate the turbulator strips. In this example, an inlet and outlet coolant header may be formed at axial ends of the housing. Further, in each fluid channel orifices may be used to control coolant flow. In a second example, multiple parallel slots are made in the stator laminations of the electric machines for accommodating turbulator strips. The turbulators enhance heat transfer in the stator and rotor to constrain losses in the electric machine. To elaborate, the turbulators enhance heat transfer performance by increasing the surface area of conducting heat and mixing. Further, multiple parallel coolant fluid channels which may be used in the cooling system to constrain hydraulic losses in the system. This stator cooling system may be used for different locations of inlet and outlet fitting on the motor's periphery via the adaptation of different orifice sizes for each fluid channel as per location of inlet fitting, outlet fitting and gravity direction.

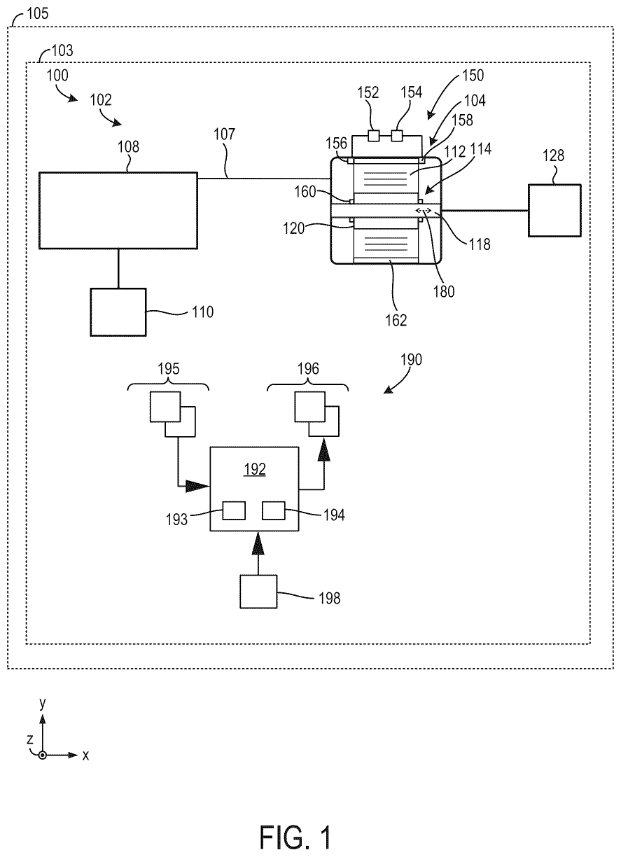

FIG. 1 shows an example of an electric drive 100 with an electric machine system 102. The electric drive 100 may be included in an electric powertrain 103 of a vehicle 105, in one example. In such an example, the electric machine included in the electric drive may be a traction motor. However, it will be understood that the electric drive 100 may be used in a variety of fields including, but not limited to, industrial machines, agricultural systems, mining systems, and the like.

In the illustrated example, the externally excited electric machine system 102 includes an electric machine 104 that is electrically coupled to an inverter 108 via electrical connections 107 (e.g., wires, bus bars, combinations thereof, and the like).

In the electric drive 100, the inverter 108 is electrically coupled to the electric machine 104. The inverter 108 may be electrically connected to an energy storage device 110 (e.g., one or more traction batteries, capacitor(s), fuel cell(s), combinations thereof, and the like). As such, electrical energy may flow between the inverter and the energy storage device during drive operation and regeneration operation, when the electric machine 104 is designed as a motor-generator.

The electric machine 104 includes a stator 112 and a rotor 114. The rotor 114 includes a rotor shaft 118 and a rotor core 120. The electric drive 100 may be coupled to downstream components 128. In the EV example, the downstream components 128 may include one or more drive axle assemblies, drive wheels, a transmission (e.g., a gearbox), combinations thereof, and the like.

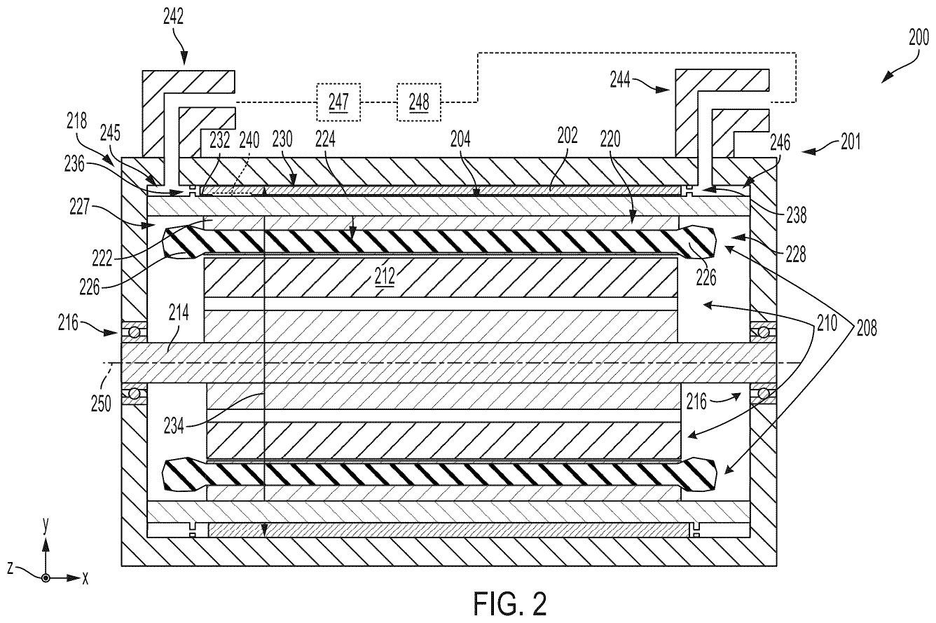

The electric machine 102 further includes a stator cooling system 150 that is configured to remove heat from the stator 112. The stator cooling system 150 is schematically depicted in FIG. 1. However, it will be understood that the cooling system has greater complexity that is elaborated upon herein with regard to the example cooling systems depicted in FIGS. 2-9 and 11.

The stator cooling system 150, in the illustrated example, includes a heat exchanger 152 and a pump 154. The heat exchanger 152 and the pump 154 are depicted external to the electric machine 102, in the illustrated example. However, the heat exchanger and/or the pump may be incorporated into the electric machine, in other examples.

In one example, the outlet of the heat exchanger 152 may be in fluidic communication with an inlet 156 of a stator cooling assembly 162 and the inlet of the pump may be in fluidic communication with an outlet 158 of the stator cooling assembly and/or a sump in the electric machine. In another example, the outlet of the pump may be in fluidic communication with the stator cooling assembly and the inlet of the heat exchanger may be in fluidic communication with a sump or in direct fluidic communication with the stator cooling assembly. Various architectures of exemplary stator cooling systems are shown in FIGS. 2-9 and discussed in greater detail herein.

The stator cooling system 150 includes the stator cooling assembly 162 which is schematically depicted in FIG. 1. However, it will be understood that the cooling assembly has greater complexity, in practice, that is expanded upon herein. The stator cooling assembly 162 may include a coolant jacket with turbulators, in one embodiment. In another embodiment, the stator cooling assembly 162 may include turbulators that is incorporated into a lamination stack in a stator core. Different examples of the stator cooling assembly are depicted in FIGS. 2-9 and discussed in greater detail herein.

The coolant in the stator cooling system 150 depicted in FIG. 1 as well as the other cooling systems described herein may be oil or a water based coolant such as a mixture of water and glycol. Bearings 160 are coupled to the rotor shaft 118 in the illustrated example.

The electric drive 100 may further include a control system 190 with a controller 192 as shown in FIG. 1. The controller 192 may include a microcomputer with components such as a processor 193 (e.g., a microprocessor unit), input/output ports, an electronic storage medium 194 for executable programs and calibration values (e.g., a read-only memory chip, random access memory, keep alive memory, a data bus, and the like). The storage medium may be programmed with computer readable data that represents instructions that are executable by a processor for performing the methods and control techniques described herein as well as other variants that are anticipated but not specifically listed. As such, control techniques, methods, and the like expanded upon herein may be stored as instructions in non-transitory memory.

The controller 192 may receive various signals from sensors 195 coupled to various regions of the electric drive 100. For example, the sensors 195 may include a rotor current sensor, an electric machine speed sensor, a stator current sensor, an electric machine temperature sensor, an auxiliary contact sensor, a battery state of charge sensor, an inverter current sensor, and the like. Electric machine speed may be ascertained from the amount of power sent from the inverter 108 to the electric machine 104. An input device 198 (e.g., an accelerator pedal, a brake pedal, a drive mode selector, a gear selector, combinations thereof, and the like, in the EV example) may further provide input signals indicative of an operator's intent for electric drive control.

Although, one controller is depicted in FIG. 1, it will be understood that the electric drive and the system in which it is incorporated, such as a vehicle, may include multiple controllers. For instance, in the EV example, a vehicle control unit (VCU) may be included in the control system 190. Additionally, a motor control unit (MCU) may be included in the control system. In such an example, the VCU and the MCU may be distinct controllers with independent hardware and may be formed in separate enclosures which are spaced away from one another. However, in other examples, the VCU and the MCU may be collocated. In either case, the VCU and the MCU are in electronic communication with one another.

Upon receiving the signals from the various sensors 195 of FIG. 1, the controller 192 processes the received signals, and employs various actuators 196 of the electric drive components to adjust the components based on the received signals and instructions stored on the memory of controller 192. For example, the controller 192 may receive a signal indicative of an operator's request for increased electric machine output. In response, the controller 192 may command operation of the inverter 108 to adjust the electric machine's mechanical power output and increase the power delivered from the electric machine 104 to the downstream components 128. The other controllable components in the electric drive may function in a similar manner in relation to sensor inputs and command outputs.

An axis system is provided in FIG. 1 as well as FIGS. 2-9 for reference, when appropriate. The y-axis may be a vertical axis (e.g., parallel to a gravitational axis), the z-axis may be a lateral axis (e.g., horizontal axis), and the x-axis may be a longitudinal axis, in one example. However, in other examples, the axes may have other orientations. Further, a rotational axis 180 of the electric machine 104 is provided in FIG. 1 for reference.

FIGS. 2-8 show examples of cooling systems which may be used in the electric machine 104 shown in FIG. 1 or other suitable electric machines.

FIGS. 2-6 specifically show one example of an electric machine 200 with a stator cooling system 201 that includes turbulators 202 incorporated into a coolant jacket 204 that is enclosed by a housing 218.

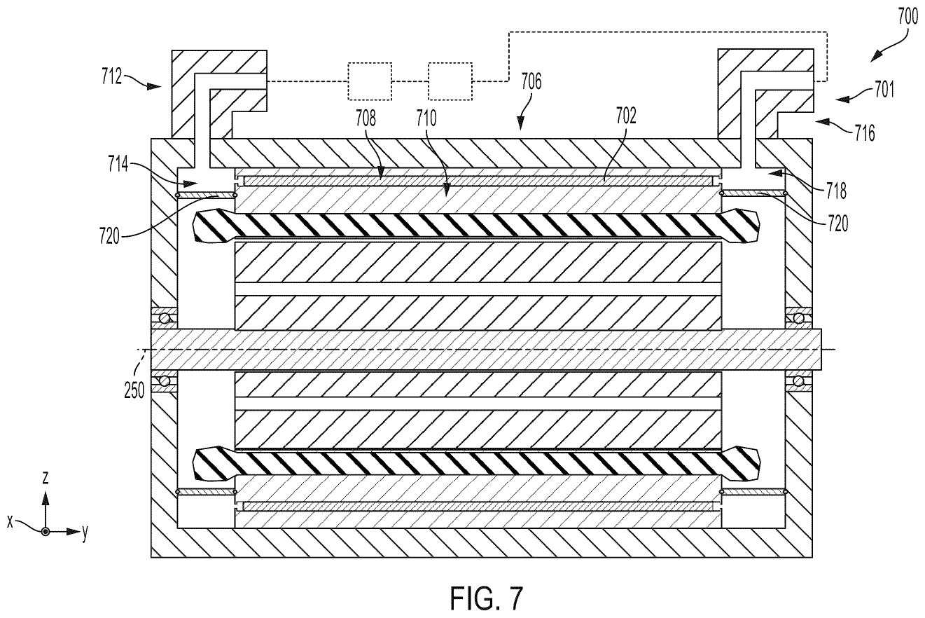

FIG. 2 specifically shows a cross-sectional view of a stator 208 and a rotor 210 in the electric machine 200. The cutting planes for the cross-sectional view shown in FIG. 2 as well as FIG. 7 extend through a rotational axis 250 of the electric machine. The rotor 210 includes a rotor core 212 that is coupled to a rotor shaft 214. Bearings 216 are coupled to the rotor shaft 214 and the housing 218 to permit rotation of the rotor shaft 214 and support the shaft. The stator 208 includes a stator core 220 that comprises multiple laminations 222 formed in a stack. Windings 224 are further included in the stator core 220 and form end windings 226 at opposing axial sides 227 and 228 of the stator 208.

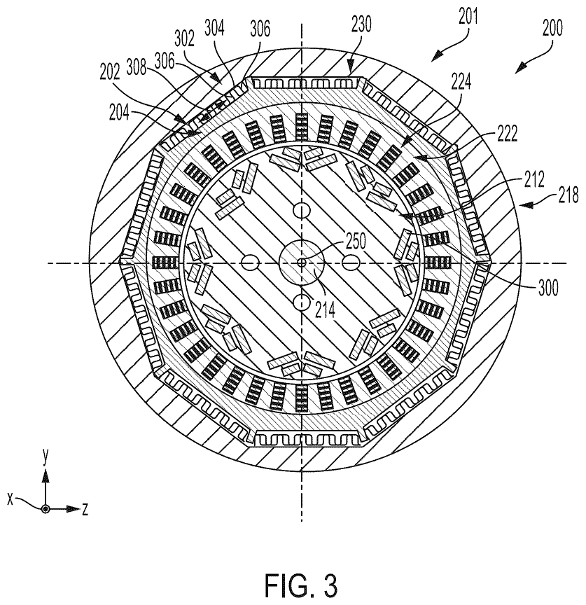

The coolant jacket 204 is coupled to the stator core 220. Coolant channels 230 are further formed in the electric machine 200. To elaborate, slots 232 in the coolant jacket 204 form a portion of the coolant channel boundaries and an inner diameter 234 of the housing form an outer boundary of the coolant channels 230. Specifically, the slots 232 are arranged parallel to one another in the illustrated example. Further, in the example illustrated in FIG. 3, the slots 232 are formed in a decagonal shape in a cross-section which is perpendicular to a rotational axis of the electric machine. In this way, the stator may be more evenly cooled.

As shown in FIG. 2, the coolant jacket 204 and the coolant channels 230 are positioned radially outward from the stator windings 224, in the illustrated example. In this way, the cooling system may be more effectively incorporated into the machine in a less complex manufacturing process when compared to stator cooling systems which route coolant through regions of the stator radially inward from the windings.

Inlet orifices 236 and outlet orifices 238 are formed in the coolant jacket 204. The inlet orifices 236 and the outlet orifices 238 allow the coolant flow rate through the channel to be tuned to achieve end-use design goals. To elaborate, the size and/or number of orifices may be selected to achieve a target coolant flowrate through the channels. In the illustrated example, the are three inlet orifice and three outlet orifice per coolant channel. In this way, the coolant achieves target flow characteristics that increase the amount of heat removal from the stator.

Turbulators 202 are arranged in the coolant channels 230. The turbulators 202 are configured to generate turbulence in the coolant flowing through the coolant channels 230. The working fluid in the stator cooling system 201 may include water and/or glycol. However, in other examples, the working fluid may include oil. The turbulators 202 may be constructed out of aluminum. Further, in one example, the turbulators 202 may be brazed to coolant jacket 204. It will be understood that brazing involves joining or soldering the components via an alloy (e.g., copper and zinc). As such, when the components are brazed a layer of solder 240 may be formed between the turbulators 202 and the coolant jacket 204. Further, the coolant jacket 204 may be constructed at least partially out of aluminum. In this way, heat may be more efficiently transferred through the coolant jacket to the coolant flowing therethrough.

A coolant inlet 242 and a coolant outlet 244 are coupled to the housing 218 and provide coolant to an inlet manifold 245 and an outlet manifold 246. The inlet manifold 245 and the outlet manifold 246 are in direct fluidic communication with the inlet orifices 236 and the outlet orifices 238, in the illustrated example. However, other suitable cooling system architectures have been contemplated. The coolant inlet 242 and the coolant outlet 244 are in fluidic communication with a pump 247 and a heat exchanger 248, in the illustrated example. To elaborate, the pump 247 and the heat exchanger 248 are spaced away from the electric machine 200 in the illustrated example. However, in other examples, the pump 247 and/or the heat exchanger 248 may be coupled to the housing 218 or otherwise incorporated into the electric machine 200.

FIG. 3 shows another cross-sectional view of the electric machine 200 and the stator cooling system 201. The cutting plane for the view shown in FIG. 3, is arranged perpendicular to the rotational axis 250.

The stator laminations 222 and the windings 224 are again depicted. Further, the rotor shaft 214 and the rotor core 212 is again depicted. The rotor core 212 includes magnets 300 (e.g., permanent magnets), in the illustrated example. The housing 218 is additionally depicted in FIG. 3.

The coolant channels 230 with the turbulators 202 positioned therein, are again depicted. The turbulators 202 include sequential sections 302 that each include a top wall 304 and side walls 306 in a repeating pattern. The sequential sections 302 may be offset with regard to an axis 308. In this way, the amount of turbulence in the coolant channels is increased, thereby increasing stator cooling and machine efficiency as a consequence.

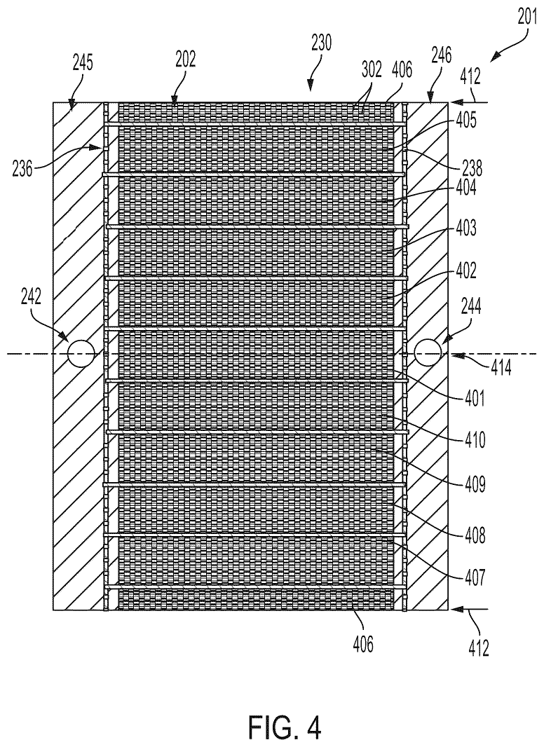

FIG. 4 shows a view of the stator cooling system 201 where the coolant channels 230 are flattened in two-dimensions. However, it will be understood, that in practice, the coolant channels 230 are arranged circumferentially around the electric machine.

The coolant inlet 242 and the coolant outlet 244 are again depicted, along with the inlet manifold 245 and the outlet manifold 246. In the illustrated example, there are ten coolant channels 401, 402, 403, 404, 405, 406, 407, 408, 409, and 410. However, the number of coolant channels may be altered based on the end-use design goals, the type and/or size of the electric machine, etc.

The inlet orifices 236 and the outlet orifices 238 are again depicted. The orifice sizes may be controlled as per the location of the coolant inlet 242 (e.g., the inlet fitting), the coolant outlet 244 (e.g., the outlet fitting), and gravity direction to achieve a more balanced flowrate (e.g., a substantially equal flow rate) though for each coolant channel (i.e., channels 401, 402, 403, 404, 405, 406, 407, 408, 409, and 410).

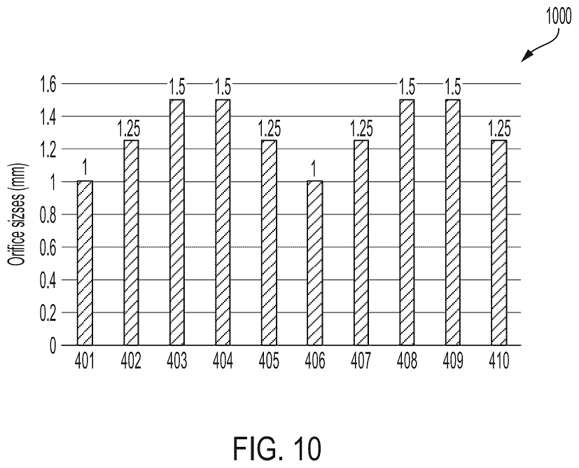

FIG. 10 shows a graph 1000 of the orifice sizes in millimeters (mm) of the different coolant channels 401, 402, 403, 404, 405, 406, 407, 408, 409, and 410, in one use-case example. The orifice sizes correspond to both the inlet and outlet orifices. In the graph 1000, the orifice size is selected to balance the coolant flowrate. However, it will be appreciated, that the orifice sizes may have a variety of values that may be selected based on the type of fluid used in the cooling system, the machine's expected operating temperature, the cooling targets of the machine, the machine's expected operating speed range, the machine's material construction, and the like. Balancing the coolant flowrate allows the stator to be more evenly cooled.

FIG. 4 again shows the turbulators 202 with the sequential sections 302 that each extend laterally across the corresponding coolant channel. The sequential sections 302 allow a greater amount of turbulence to be generated in the coolant channels, thereby increasing the amount of heat that can be removed from the electric machine by the stator cooling system. The bottom 412 and the top 414 of the stator cooling system 201 are indicated in FIG. 4, for reference.

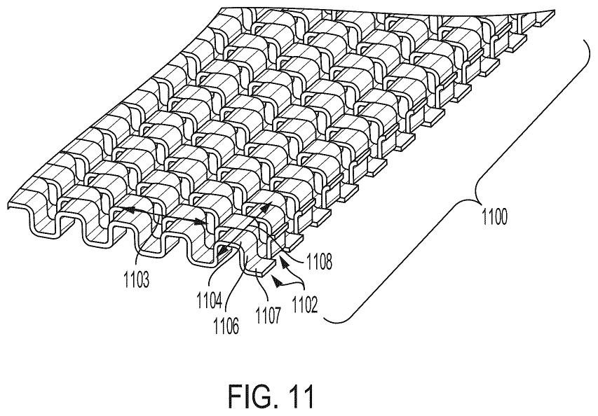

FIG. 11 shows a detailed view of exemplary turbulators 1100 that may be included in any of the cooling systems described herein. To elaborate, each of the turbulators 1100 may be formed as strips 1102 that are laterally aligned with regard to the coolant channel in which they are arranged. A lateral axis 1103 is indicated in FIG. 11, for reference. In the illustrated example, the sequential strips are laterally offset such that the top wall 1104, side walls 1106, and bottom walls 1107 are not longitudinally aligned along an axis 1108.

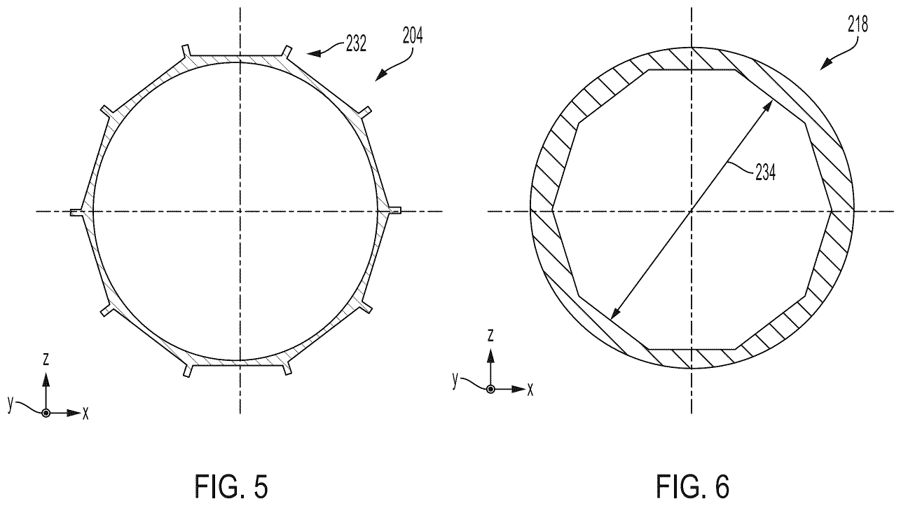

FIG. 5 shows a detailed cross-sectional view of the coolant jacket 204. The slots 232 in the coolant jacket 204 form a portion of the boundary of the coolant channels. FIG. 6 shows the housing 218 with the inner diameter 234 that forms the other portion of the boundaries of the coolant channels.

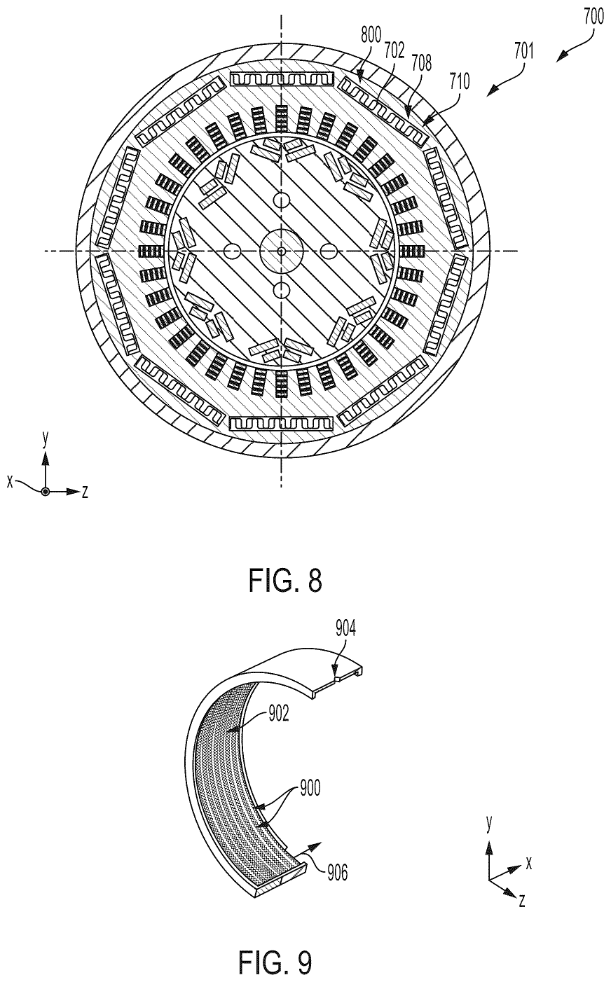

FIGS. 7-8 show another example of an electric machine 700 with a stator cooling system 701 that includes turbulators 702 that are incorporated into a stator lamination stack 710 that is enclosed by a housing 706.

The stator cooling system 701 shown in FIGS. 7-8 include many overlapping structural and function features. Redundant description of these overlapping features, is omitted for brevity.

The stator cooling system 701 shown in FIG. 7 includes coolant channels 708 extending through the stator lamination stack 710. Turbulators 702 (which may have a similar geometry to the previously described turbulators) are positioned within the coolant channels 708. A coolant inlet 712 provides coolant flow to an inlet manifold 714 that is in direct fluidic communication with the coolant channels 708, in the illustrated example. Likewise, a coolant outlet 716 receives coolant from an outlet manifold 718 that is in direct fluidic communication with the coolant channels 708. Seals 720 may be provided in the cooling system, to reduce the chance of fluid leakage into undesirable areas in the electric machine.

FIG. 8 again shows the stator lamination stack 710, the coolant channels 708, and the turbulators 702 positioned in the coolant channels. The turbulators 702 may again include sequential sections 800 that each include a top wall and side walls, in a repeating pattern, similar to the previously described turbulators.

FIG. 9 shows a cross-sectional view of a detailed example of turbulators 900 in a coolant channel 902 that may be used in any of the cooling systems described herein or combinations of the cooling systems. An inlet 904 and an outlet 906 of the coolant channel 902 is shown in FIG. 9. The inner boundary of the coolant channel 902 has been omitted from FIG. 9 to reveal the interior of the coolant channel where the turbulators 900 are placed.

The technical effect of the electric machines described herein is to increase machine efficiency through efficient stator cooling.

FIGS. 2, 3, 4, 5,6, 7, 8, 9, and 11 are drawn to scale, although other relative dimensions may be used if desired.

FIGS. 1-9 shows example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Additionally, elements co-axial with one another may be referred to as such, in one example. Further, elements shown intersecting one another may be referred to as intersecting elements or intersecting one another, in at least one example. Further still, an element shown within another element or shown outside of another element may be referred as such, in one example. In other examples, elements offset from one another may be referred to as such.

The invention will be further described in the following paragraphs. In one aspect, a stator cooling system in an electric machine is provided that comprises multiple coolant channels arranged in a stator lamination stack or between an outer diameter of a coolant jacket and an inner diameter of a housing; multiple turbulators arranged the multiple coolant channels; a coolant inlet configured to deliver a coolant to multiple coolant channels; and a coolant outlet configured to receive the coolant from the multiple coolant channels. In one example, the multiple coolant channels may axially extend through the stator lamination stack. In another example, the multiple coolant channels may axially extend through the coolant jacket; and the coolant jacket may be directly coupled to the stator lamination stack. In yet another example, each turbulator in the multiple turbulators may include sequential sections that each include a top wall and opposing sidewalls that extend inward toward a rotational axis of the electric machine. In another example, the top wall and the opposing sidewalls may be axially aligned. In yet another example, each of the multiple coolant channels may include multiple inlet flow control orifices and multiple outlet flow control orifices. In another example, the multiple coolant channels may each be formed as slots in a decagonal shape in a cross-section which is perpendicular to a rotational axis of the electric machine. In another example, the multiple turbulators may be constructed out of aluminum. In another example, the coolant jacket may be constructed out of aluminum. In another example, the multiple coolant channels may be positioned radially outward from stator windings. In yet another example, the multiple turbulators may be coupled to the coolant jacket via brazing.

In yet another example, a method for operating a stator cooling system is provided that comprises flowing coolant into a coolant inlet via operation of a pump; wherein the stator cooling system includes: multiple coolant channels arranged in a stator lamination stack or between an outer diameter of a coolant jacket and an inner diameter of a housing; multiple turbulators arranged the multiple coolant channels; the coolant inlet; and a coolant outlet configured to receive the coolant from the multiple coolant channels. In another example, the pump may be coupled to the housing. In yet another example, the multiple coolant channels may be positioned radially outward from stator windings.

In another aspect, a stator cooling system in an electric machine is provided that comprises multiple coolant channels arranged between an outer diameter of a coolant jacket and an inner diameter of a housing; multiple turbulators arranged the multiple coolant channels; a coolant inlet configured to deliver a coolant to multiple coolant channels; and a coolant outlet configured to receive the coolant from the multiple coolant channels. In one example, each turbulator in the multiple turbulators may include a first section including a top wall and opposing sidewalls that extend inward toward a rotational axis of the electric machine; and a second section positioned downstream and laterally offset from the first section and including a top wall and opposing sidewalls that extend inward toward a rotational axis of the electric machine. In yet another example, the multiple turbulators may be constructed out of aluminum; and the multiple turbulators may be coupled to the coolant jacket via brazing. In another example, each of the multiple coolant channels may include three inlet flow control orifices and three outlet flow control orifices per coolant channel. In yet another example, the multiple coolant channels may be formed in a decagonal shape in a cross-section which is perpendicular to a rotational axis of the electric machine. In another example, the multiple coolant channels may be positioned radially outward from stator windings.

While various embodiments have been described above, it should be understood that they have been presented by way of example, and not limitation. It will be apparent to persons skilled in the relevant arts that the disclosed subject matter may be embodied in other specific forms without departing from the spirit of the subject matter. The embodiments described above are therefore to be considered in all respects as illustrative, not restrictive. As such, the configurations and routines disclosed herein are exemplary in nature, and that these specific examples are not to be considered in a limiting sense, because numerous variations are possible. For example, the above technology can be applied to a variety of systems that include electric drives with different types of propulsion sources including internal combustion engines, in a hybrid vehicle example. The subject matter of the present disclosure includes all novel and non-obvious combinations and sub-combinations of the various systems and configurations, and other features, functions, and/or properties disclosed herein.

Note that the example control and estimation routines included herein can be used with various electric drive and/or cooling system configurations. The control methods and routines disclosed herein may be stored as executable instructions in non-transitory memory and may be carried out by the control system including the controller in combination with the various sensors, actuators, and other electric drive and/or system hardware in combination with the electronic controller. As such, the described actions, operations, and/or functions may graphically represent code to be programmed into non-transitory memory of the computer readable storage medium in the electric drive and/or the system. The various actions, operations, and/or functions illustrated may be performed in the sequence illustrated, in parallel, or in some cases omitted. Likewise, the order of processing is not necessarily required to achieve the features and advantages of the examples described herein, but is provided for ease of illustration and description. One or more of the illustrated actions, operations and/or functions may be repeatedly performed depending on the particular strategy being used. One or more of the method steps described herein may be omitted if desired.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. A stator cooling system in an electric machine, comprising:
multiple coolant channels arranged in a stator lamination stack or between an outer diameter of a coolant jacket and an inner diameter of a housing;
multiple turbulators arranged the multiple coolant channels;
a coolant inlet configured to deliver a coolant to multiple coolant channels; and
a coolant outlet configured to receive the coolant from the multiple coolant channels.

2. The stator cooling system of claim 1, wherein the multiple coolant channels axially extend through the stator lamination stack.

3. The stator cooling system of claim 1, wherein:
the multiple coolant channels axially extend through the coolant jacket; and
the coolant jacket is directly coupled to the stator lamination stack.

4. The stator cooling system of claim 1, wherein each turbulator in the multiple turbulators include sequential sections that each include a top wall and opposing sidewalls that extend inward toward a rotational axis of the electric machine.

5. The stator cooling system of claim 4, wherein the top wall and the opposing sidewalls are axially aligned.

6. The stator cooling system of claim 1, wherein each of the multiple coolant channels include multiple inlet flow control orifices and multiple outlet flow control orifices.

7. The stator cooling system of claim 1, wherein the multiple coolant channels are each formed as slots in a decagonal shape in a cross-section which is perpendicular to a rotational axis of the electric machine.

8. The stator cooling system of claim 1, wherein the multiple turbulators are constructed out of aluminum.

9. The stator cooling system of claim 8, wherein the coolant jacket is constructed out of aluminum.

10. The stator cooling system of claim 1, wherein the multiple coolant channels are positioned radially outward from stator windings.

11. The stator cooling system of claim 1, wherein the multiple turbulators are coupled to the coolant jacket via brazing.

12. A method for operating a stator cooling system, comprising:
flowing coolant into a coolant inlet via operation of a pump;
wherein the stator cooling system includes:
multiple coolant channels arranged in a stator lamination stack or between an outer diameter of a coolant jacket and an inner diameter of a housing;
multiple turbulators arranged the multiple coolant channels;
the coolant inlet; and
a coolant outlet configured to receive the coolant from the multiple coolant channels.

13. The method of claim 12, wherein the pump is coupled to the housing.

14. The method of claim 12, wherein the multiple coolant channels are positioned radially outward from stator windings.

15. A stator cooling system in an electric machine, comprising:
multiple coolant channels arranged between an outer diameter of a coolant jacket and an inner diameter of a housing;
multiple turbulators arranged the multiple coolant channels;
a coolant inlet configured to deliver a coolant to multiple coolant channels; and
a coolant outlet configured to receive the coolant from the multiple coolant channels.

16. The stator cooling system of claim 15, wherein each turbulator in the multiple turbulators includes:
a first section including a top wall and opposing sidewalls that extend inward toward a rotational axis of the electric machine; and
a second section positioned downstream and laterally offset from the first section and including a top wall and opposing sidewalls that extend inward toward a rotational axis of the electric machine.

17. The stator cooling system of claim 15, wherein:
the multiple turbulators are constructed out of aluminum; and
the multiple turbulators are coupled to the coolant jacket via brazing.

18. The stator cooling system of claim 15, wherein each of the multiple coolant channels include three inlet flow control orifices and three outlet flow control orifices per coolant channel.

19. The stator cooling system of claim 15, wherein the multiple coolant channels are formed in a decagonal shape in a cross-section which is perpendicular to a rotational axis of the electric machine.

20. The stator cooling system of claim 19, wherein the multiple coolant channels are positioned radially outward from stator windings.
